(19) United States
(12) Patent Application Publication
(10) Pub. No.: US 2023/0122879 A1
(43) Pub. Date: Apr. 20, 2023

(54) ADDRESSING FOR SATELLITE DEVICES USING WIRELESS LOCALIZATION

(71) Applicant: TEXAS INSTRUMENTS INCORPORATED, Dallas, TX (US)

(72) Inventors: Fernando David LARA ALVA, Frisco, TX (US); Donovan Allen PORTER, Dallas, TX (US); Arun Tej VEMURI, Dallas, TX (US)

(21) Appl. No.: 17/504,300

(22) Filed: Oct. 18, 2021

(51) Int. Cl. H04W 8/26; H04W 4/80; H04B 7/185; H04L 12/40

(52) U.S. Cl. CPC H04W 8/26; H04W 4/80; H04B 7/18513; H04L 12/40; H04L 2012/40273; H04L 2012/40215

(57) ABSTRACT

A method includes receiving, by a central device over a wireless communication link, a first advertising packet from a first satellite device; receiving, by the central device over the wireless communication link, a second advertising packet from a second satellite device; determining a first location of the first satellite device responsive to a first wireless localization value of the first advertising packet; and assigning, by the central device, a first network address to the first satellite device responsive to the determined first location.

### CROSS-REFERENCE TO RELATED APPLICATIONS

The present application is related to U.S. Provisional Patent Application No. 62/964,862, which was filed Jan. 23, 2020, is titled “Wireless Auto-Addressing For Vehicle Modules Using Bluetooth Localization Techniques,” and is hereby incorporated herein by reference in its entirety.

### SUMMARY

In accordance with at least one example of the disclosure, a method includes receiving, by a central device over a wireless communication link, a first advertising packet from a first satellite device; receiving, by the central device over the wireless communication link, a second advertising packet from a second satellite device; determining a first location of the first satellite device responsive to a first wireless localization value of the first advertising packet; and assigning, by the central device, a first network address to the first satellite device responsive to the determined first location.

In accordance with another example of the disclosure, a system includes a central device and first and second satellite devices coupled to the central device over a wired network bus. The central device is configured to receive, over a wireless communication link, a first advertising packet from the first satellite device; receive, over the wireless communication link, a second advertising packet from the second satellite device; determine a first location of the first satellite device responsive to a first wireless localization value of the first advertising packet; and assign a first network address, over the wired network bus, to the first satellite device responsive to the determined first location.

In accordance with yet another example of the disclosure, a device includes a processor and a memory containing instructions executable by the processor. The instructions, when executed by the processor, cause the device to be configured to receive, over a wireless communication link, a first advertising packet from a first satellite device; receive, over the wireless communication link, a second advertising packet from a second satellite device; determine a first location of the first satellite device responsive to a first wireless localization value of the first advertising packet; and assign a first wired network address to the first satellite device responsive to the determined first location.

### BRIEF DESCRIPTION OF THE DRAWINGS

For a detailed description of various examples, reference will now be made to the accompanying drawings in which:

FIG. 1 is a schematic diagram of a system for addressing using wireless localization in accordance with various examples;

FIG. 2 is a schematic diagram of an example of determining locations of satellite devices in the system of FIG. 1 using wireless localization in accordance with various examples;

FIG. 3 is a schematic diagram of another example of determining locations of satellite devices in the system of FIG. 1 using wireless localization in accordance with various examples;

FIG. 4 is a timing diagram of a wireless localization technique in accordance with various examples;

FIG. 5 is a block diagram of a central device in the system of FIG. 1 in accordance with various examples; and

FIG. 6 is a flowchart of a method for addressing using wireless localization in accordance with various examples.

### DETAILED DESCRIPTION

Bluetooth (BT) and Bluetooth Low Energy (BLE) are communication protocol standards that facilitate wireless data transmission over a radio link. A BLE access network includes multiple BLE access nodes. In one example, a BLE access network is used in an automotive (e.g., vehicle-based) access application, such as a remote keyless entry (RKE) and/or a passive entry, passive start (PEPS) application. Multiple BLE access nodes are deployed around the vehicle to enable localization of a BT/BLE-enabled remote device, such as a user's mobile device or a key fob. The BLE access network includes a BLE central device (a “central”) and one or more BLE peripheral devices (each a “peripheral” or a “satellite”). In this description, the device identified as a BLE central is generally referred to as performing a BLE central role. However, in other examples, such devices can be multi-role devices, and can function as a BLE central at some times, and as a BLE peripheral at other times. In the example in which the BLE access network is a vehicle access network, the BLE central exchanges data with the BLE satellites over a vehicle controller area network (CAN) bus.

It is useful to use similar (e.g., identical) hardware and/or parts for each of the BLE satellites because this simplifies, and increases the efficiency of, the manufacturing and inventory management of BLE satellites. For example, if a certain vehicle access network includes one BLE central and six BLE satellites, it is simpler and more efficient to install a same part in six locations of the vehicle, rather than to install one of six unique parts in each of those six locations. However, each of the BLE satellites should have a different, unique CAN address to facilitate communication between the BLE central and the BLE satellites over the CAN bus (e.g., for the vehicle access system to identify the location of the user's mobile device or key fob).

For example, a first CAN address is to be associated with the BLE satellite installed in a first location (e.g., proximate to the driver-side door of the vehicle) and a second CAN address is to be associated with the BLE satellite installed in a second location (e.g., proximate to the trunk of the vehicle). Subsequently, when the BLE central receives first data from the first CAN address, the BLE central is aware that the received data is associated with, or provided by, the BLE satellite in the first location, and the BLE central processes that first data accordingly. Similarly, when the BLE central receives second data from the second CAN address, the BLE central is aware that the received data is associated with, or provided by, the BLE satellite in the second location, and the BLE central processes that second data accordingly. However, because each of the BLE satellites includes like hardware and/or parts, the BLE central programs or assigns a unique CAN address to each of the BLE satellites (e.g., after installation) that identifies or specifies the location of that BLE satellite. In some cases, a wired connection (e.g., a local interconnect network (LIN) or other wired bus in addition to the CAN bus) is installed in the vehicle to enable the BLE central to assign unique CAN addresses to the BLE satellites. For example, the BLE central is programmed to send a LIN message over the LIN bus to the BLE satellites in a daisy-chained fashion to provide each of the BLE satellites with a CAN address. However, providing an additional wired bus in addition to the CAN bus increases cost and complexity of implementing the BLE access network in the vehicle.

Examples of this description address the foregoing by providing a wireless localization technique to determine a relative distance or position between the BLE central and various BLE satellites. The wireless localization technique can be based on one or more of a received signal strength indicator (RSSI), an angle of arrival, trilateration, or other wireless localization techniques. Because there is predetermined or existing knowledge of the system (e.g., vehicle) topology, the BLE satellite location(s) are identifiable based on the different RSSIs or other wireless localization values. For example, if the BLE central is located in the dashboard area, the first BLE satellite (S1) is located in the driver-side door area, and the second BLE satellite (S2) is located in the trunk area, RSSI(S1) is greater than RSSI(S2). Accordingly, the BLE central identifies S1 as being located in the driver-side door area, and assigns a first network address (e.g., a CAN address) to S1 that identifies or specifies the location of S1 as being the driver-side door area. Similarly, the BLE central identifies S2 as being located in the trunk area, and assigns a second network address (e.g., a CAN address) to S2 that identifies or specifies the location of S2 as being the trunk area.

In some examples, RSSIs at the BLE central can be similar for certain BLE satellites, such as where those certain BLE satellites are approximately equidistant from the BLE central. However, responsive to at least one BLE satellite location being determined, the located BLE satellite can then be used to determine additional localization values for the still unlocated BLE satellites in a similar manner. For example, RSSIs are determined between the located BLE satellite and the unlocated BLE satellites, and locations are determined based on differences in those RSSIs and the known topology of the system/vehicle. These and other examples are described below, with reference made to the accompanying figures.

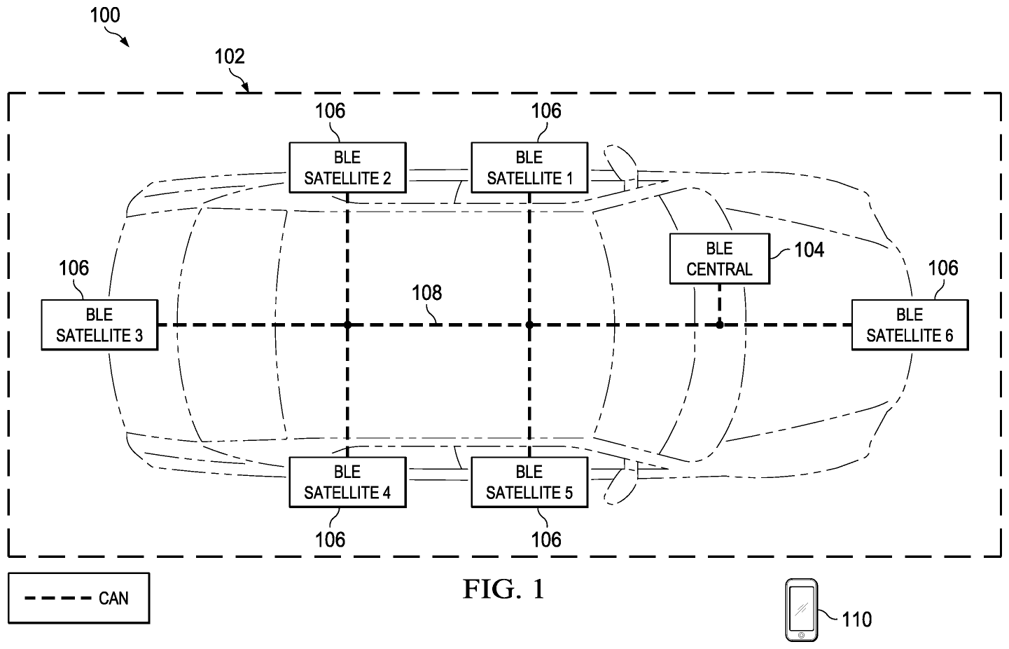

FIG. 1 is a schematic diagram of a system 100 for addressing using wireless localization in accordance with examples of this description. The system 100 includes an access network 102, which is depicted as part of a vehicular access application in the example of FIG. 1. The access network 102 includes a central 104 and multiple satellites 106. The satellites 106 and/or the central 104 can function as access nodes for the access network 102. Although the access network 102 is shown as including six satellites 106 (e.g., Satellite 1 (S1)-Satellite 6 (S6)), the access network 102 includes more or fewer satellites 106 in other examples.

As described above, in some examples, the access network 102 is a BLE access network 102, the central 104 is a BLE central 104, and the satellites 106 are BLE satellites 106. As described above, in an example in which the access network 102 is a vehicle access network 102, a CAN bus 108 (e.g., a wired connection) enables the exchange of data between the BLE central 104 and the BLE satellites 106.

The system 100 also includes a remote device 110, such as a user's mobile device or key fob. In this example, the remote device 110 is a vehicle key and the access network 102 is part of a vehicle. When a user possessing the remote device 110 is within a certain proximity to the vehicle access network 102 (or a BLE satellite 106 thereof), the user is permitted to lock or unlock the vehicle, start or stop a motor of the vehicle, or otherwise alter a configuration of the vehicle. In the vehicle access network 102 example, it is useful for the BLE satellites 106 to be uniquely addressed, so that the addresses of the BLE satellites 106 identify or specify the location of the BLE satellites 106 in the vehicle access network 102. For example, a first network address (e.g., a CAN address) is assigned to BLE satellite 106 S1 that identifies or specifies the location of BLE satellite 106 S1 as being the driver-side front door area. Similarly, a second network address (e.g., a CAN address) is assigned to BLE satellite 106 S3 that identifies or specifies the location of BLE satellite 106 S3 as being the trunk area. Accordingly, the BLE central 104 can be configured to selectively permit access (e.g., locking/unlocking a door) to the vehicle responsive to data received from the BLE satellites 106.

For example, the BLE central 104 receives data from BLE satellite 106 S1 that indicates the remote device 110 (e.g., acting as a vehicle key) is sufficiently close to BLE satellite 106 S1 (e.g., less than an access threshold distance), and unlocks the driver-side front door (or permits the driver-side front door to be unlocked, such as responsive to user contact with a front door handle). However, in an example, the BLE central 104 does not permit access to the trunk responsive to data from BLE satellite 106 S1 indicating the remote device 110 is sufficiently close to BLE satellite 106 S1, because the remote device 110 is not proximate to the trunk. In another example, the BLE central 104 receives data from BLE satellite 106 S3 that indicates the remote device 110 (e.g., acting as a vehicle key) is sufficiently close to BLE satellite 106 S3, and unlocks the trunk (or permits the trunk to be unlocked, such as responsive to user contact with a trunk handle). However, in an example, the BLE central 104 does not permit access to the driver-side front door responsive to data from BLE satellite 106 S3 indicating the remote device 110 is sufficiently close to BLE satellite 106 S3, because the remote device 110 is not proximate to the driver-side front door. The foregoing example is one that demonstrates the utility of the BLE central 104 being able to uniquely identify (e.g., responsive to unique, per-satellite addresses) the BLE satellite 106 location from which various data is received. However, the scope of the present description is not limited to the foregoing example, and is applicable to various such examples in both the vehicle access network 102 context, as well as wireless access networks 102 in non-vehicular contexts.

In some examples, the multiple BLE satellites 106 are deployed around the vehicle to enable the maintenance and management of continuous BT/BLE connectivity to, and localization of, the user's remote device 110 (or a key fob 110) functioning as the vehicle key. For example, the remote device 110 is configured to communicate with the access network 102 (e.g., communicate with the BLE satellites 106, which in turn provide data to the BLE central 104 over the CAN bus 108) via a wireless communication link between the remote device 110 and one of the BLE satellites 106 of the access network 102.

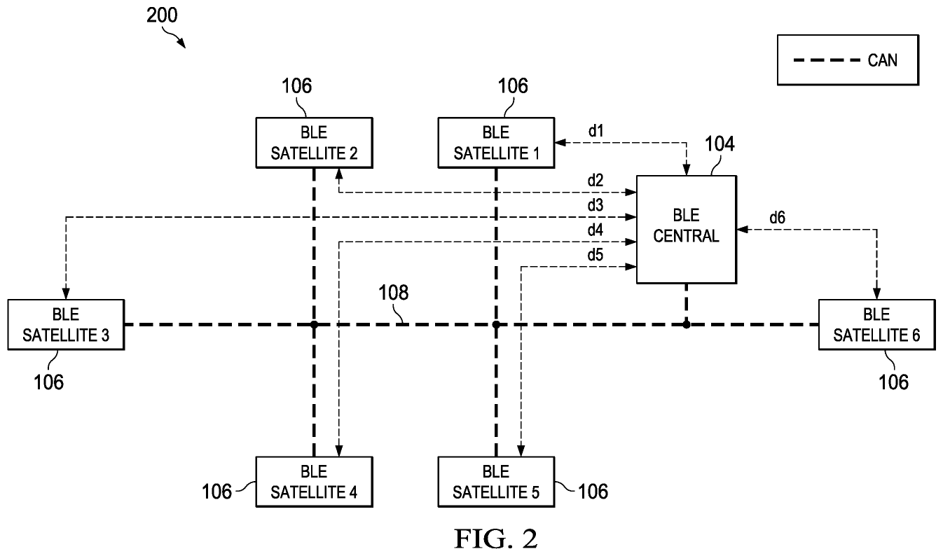

FIG. 2 is a schematic diagram 200 of an example of determining locations of satellites 106 in the system 100 of FIG. 1 using wireless localization in accordance with various examples. In the example of FIG. 2, a distance between the BLE central 104 and each of the BLE satellites 106 is indicated. For example, d1 is the distance between the BLE central 104 and BLE satellite 106 S1, d2 is the distance between the BLE central 104 and BLE satellite 106 S2, d3 is the distance between the BLE central 104 and BLE satellite 106 S3, d4 is the distance between the BLE central 104 and BLE satellite 106 S4, d5 is the distance between the BLE central 104 and BLE satellite 106 S5, and d6 is the distance between the BLE central 104 and BLE satellite 106 S6. As described above, a system 100 (e.g., vehicle) topology is predetermined or already known to the BLE central 104. In this example, the topology can be described by d1<d6<d5<d2<d4<d3.

The BLE central 104 is configured to determine a relative distance or position between itself and the BLE satellites 106 using a wireless localization technique. For example, the wireless localization technique is based on one or more of an RSSI, an angle of arrival, trilateration, or other wireless localization techniques. Because there is predetermined or existing knowledge of the system 100 (e.g., vehicle) topology, the location of a particular BLE satellite 106 is identifiable based on the RSSI for that BLE satellite 106. In the following examples, reference is generally made to RSSI values; however, the principles described herein can be extended to different wireless localization techniques and determined values as well.

The BLE central 104 is configured to receive advertising packets from one or more of the BLE satellites 106. In an example, the BLE satellites 106 are configured to broadcast such advertising packets over a wireless communication link (e.g., a BT link) during an initialization period following the installation of the BLE satellites 106 in the access network 102 (e.g., after the BLE satellites 106 are installed in a vehicle). The BLE satellites 106 can include a true random number generator (TRNG) that is configured to generate an identifier (e.g., a random number) to be included with the advertising packet, because in some cases, the BLE satellites 106 do not yet have an associated, unique identifier (e.g., a CAN address). The TRNG functionality of the BLE satellites 106 is described further below.

The BLE central 104 is also configured to determine a wireless localization value (e.g., an RSSI value) of the advertising packets. In some examples, the BLE central 104 receives multiple advertising packets for a BLE satellite 106 and determines an average RSSI responsive to the RSSIs of the multiple advertising packets from that BLE satellite 106.

Irrespective of whether the BLE central 104 determines a single RSSI value or an average of multiple RSSI values for a particular BLE satellite 106, the BLE central 104 is configured to determine a location of the BLE satellite 106 responsive to the RSSI value or average of RSSI values. For example, the BLE central 104 is configured to convert the RSSI (or average thereof) into a distance (e.g., one of the distances d1-d6), based on the relation between power density at a distance R from an isotropic antenna transmitting P watts of radio frequency (RF) power being

$$\frac{P}{4 π {R}^{2}} .$$

In another example, the BLE central 104 is configured to determine a closest BLE satellite 106. For example, in the vehicle access network 102 context, an RSSI range is from approximately −30 decibel-meters (dBm) (e.g., close in inches) to −90 dBm (e.g., farther in meters). In the particular example of FIG. 2, a closest BLE satellite 106 determined responsive to having a greatest RSSI (or average thereof) corresponds to BLE satellite 106 S1, while a farthest BLE satellite 106 determined responsive to having a least RSSI (or average thereof) corresponds to BLE satellite 106 S3. The locations of the remaining BLE satellites 106 can be identified responsive to their relative RSSIs in a similar manner.

The BLE central 104 is thus configured to determine a location of a particular BLE satellite 106 responsive to the RSSI value(s) from that particular BLE satellite's 106 advertising packet(s). The BLE central 104 is then configured to assign a network address (e.g., a CAN address) to that particular BLE satellite 106 responsive to its determined location. For example, the BLE central 104 determines that BLE satellite 106 S1 is the nearest BLE satellite 106 based on RSSI(s) of its advertising packet(s), and is thus aware that BLE satellite 106 S1 is located near the driver-side front door based on the vehicle topology described above. Accordingly, the BLE central 104 assigns a CAN address to BLE satellite 106 S1 that identifies or specifies the location of BLE satellite 106 S1 as being the driver-side front door. Similarly, the BLE central 104 determines that BLE satellite 106 S6 is the second-nearest BLE satellite 106 based on RSSI(s) of its advertising packet(s), and is thus aware that BLE satellite 106 S6 is located near the hood based on the vehicle topology described above. Accordingly, the BLE central 104 assigns a CAN address to BLE satellite 106 S6 that identifies or specifies the location of BLE satellite 106 S6 as being the vehicle hood. The above approach continues for the remaining BLE satellites 106 (S5, S2, S4, and S3).

In the above example, BLE satellite 106 S1 is in a predetermined proximal location relative to the BLE central 104, while BLE satellite 106 S6 (and the other BLE satellites 106) is in a predetermined distal location relative to the BLE central 104 (and its proximity to BLE satellite 106 S1). Accordingly, the BLE central 104 determines RSSI value(s) for advertising packets from BLE satellite 106 S1 that indicate that a distance between BLE satellite 106 S1 and the BLE central 104 is less than a distance between BLE satellite 106 S6 (and the other BLE satellites 106) and the BLE central 104.

In some examples, the location of a particular BLE satellite 106 is determined responsive to the RSSI value(s) of that BLE satellite 106, in relation to the RSSI value(s) determined for another BLE satellite 106. For example, the RSSI value(s) for S1 may be close in absolute value to the RSSI value(s) for S6. However, the RSSI value(s) for BLE satellite 106 S1 are also consistently, or on average, less than the RSSI value(s) for BLE satellite 106 S6. Accordingly, the BLE central 104 can be configured to identify the location of BLE satellite 106 S1 responsive to a comparison between its RSSI value(s) and the RSSI value(s) of another BLE satellite 106 (e.g., the next-closest BLE satellite 106 S6).

In another example, an angle between the BLE central 104 and each of the BLE satellites 106 may be different. For example, a first angle exists between a reference direction of the BLE central 104 and BLE satellite 106 S1, while a second angle exists between the reference direction of the BLE central 104 and BLE satellite 106 S2. As described above, a system 100 (e.g., vehicle) topology is predetermined or already known to the BLE central 104.

The BLE central 104 is configured to determine a relative angle between itself (e.g., the reference direction of the BLE central 104) and advertising packet(s) received from the BLE satellites 106, using an angle of arrival localization technique. Because there is predetermined or existing knowledge of the system 100 (e.g., vehicle) topology, the location of a particular BLE satellite 106 is identifiable based on the angle of arrival for advertising packet(s) from that BLE satellite 106.

As above, the BLE central 104 is configured to receive advertising packets from one or more of the BLE satellites 106. The BLE central 104 is also configured to determine an angle of arrival value of the advertising packets. In some examples, the BLE central 104 receives multiple advertising packets for a BLE satellite 106 and determines an average angle of arrival responsive to the angle of arrival values of the multiple advertising packets from that BLE satellite 106.

Irrespective of whether the BLE central 104 determines a single angle of arrival value or an average of multiple angle of arrival values for a particular BLE satellite 106, the BLE central 104 is configured to determine a location of the BLE satellite 106 responsive to the angle of arrival value or average of angle of arrival values. In this particular example, a BLE satellite 106 determined to be at the first angle relative to the BLE central 104 corresponds to BLE satellite 106 S1, while a BLE satellite 106 determined to be at the second angle relative to the BLE central 104 corresponds to BLE satellite 106 S2. The locations of the remaining BLE satellites 106 can be identified responsive to their relative angle of arrival values in a similar manner.

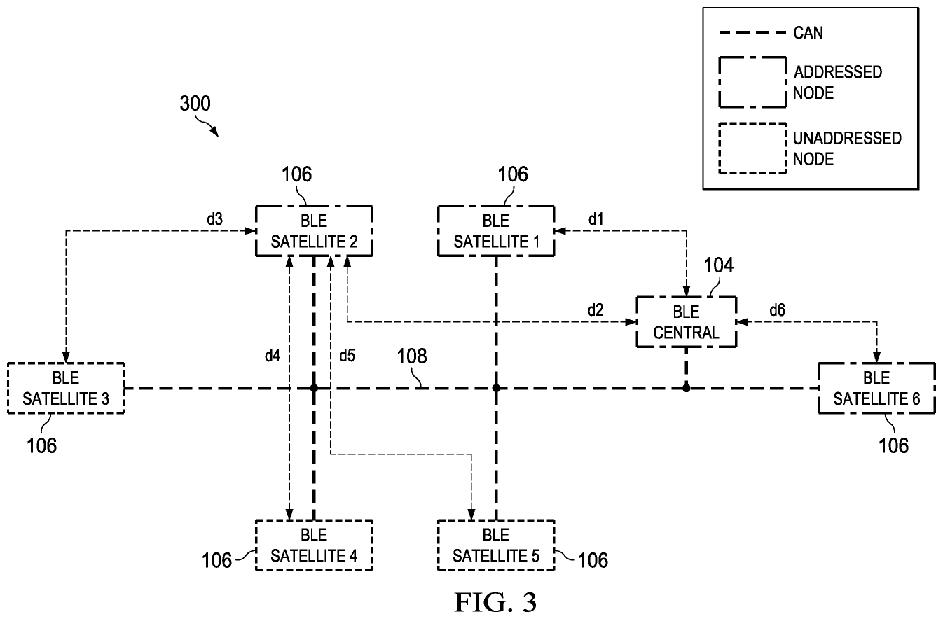

FIG. 3 is a schematic diagram 300 of another example of determining locations of BLE satellites 106 in the system 100 of FIG. 1 using wireless localization in accordance with various examples. In some examples, the BLE central 104 determines similar RSSIs for certain BLE satellites 106. In one example, similar RSSIs are determined for certain BLE satellites 106 because those BLE satellites 106 are approximately equidistant from the BLE central 104. In another example, similar RSSIs are determined for certain BLE satellites 106 because of different interference and/or obstruction present between those BLE satellites 106 and the BLE central 104 that impact the RSSI determined by the BLE central 104.

In the example of FIG. 3, the system 100 (e.g., vehicle) topology is the same as that shown in and described with respect to FIG. 2. However, in FIG. 3, the BLE central 104 is unable to determine locations for (and thus assign CAN addresses to) BLE satellites 106 S3, S4, S5. Accordingly, in FIG. 3, BLE satellites 106 S1, S2, and S6 are addressed nodes (e.g., the BLE central 104 has already assigned a CAN address to those BLE satellites 106), while BLE satellites 106 S3, S4, and S5 are unaddressed nodes. In FIG. 3, d3 is the distance between BLE satellites 106 S2 and S3, d4 is the distance between BLE satellites 106 S2 and S4, and d5 is the distance between BLE satellites 106 S2 and S5. In FIG. 3, d3<d4<d5.

The BLE central 104 is thus configured to use one of the located (e.g., addressed) BLE satellites 106 to determine additional localization values for the still unlocated BLE satellites 106. For example, BLE satellite 106 S2 is configured to determine RSSI values between itself and one or more of the unlocated BLE satellites 106 (S3, S4, S5). BLE satellite 106 S2 is also configured to provide those determined RSSI values to the BLE central 104 for further processing.

In the particular example of FIG. 3, when BLE satellite 106 S2 determines RSSIs for the remaining unaddressed BLE satellites 106 (S3, S4, S5), a closest BLE satellite 106 determined responsive to having a greatest RSSI (or average thereof) corresponds to BLE satellite 106 S3, while a farthest BLE satellite 106 determined responsive to having a least RSSI (or average thereof) corresponds to BLE satellite 106 S5. The location of BLE satellites 106 S4 can be identified responsive to being the BLE satellite 106 having an intermediate RSSI.

The BLE central 104 is thus configured to determine a location of unaddressed BLE satellites 106 (e.g., S3, S4, S5) responsive to the RSSI value(s) from that particular BLE satellite's 106 advertising packet(s) as received by one of the addressed BLE satellites 106 (e.g., S2). The BLE central 104 is then configured to assign a network address (e.g., a CAN address) to those yet-to-be addressed BLE satellites 106 responsive to their determined locations relative to BLE satellite 106 S2. For example, the BLE central 104 determines that BLE satellite 106 S3 is the nearest BLE satellite 106 to BLE satellite 106 S2 based on RSSI(s) of its advertising packet(s) received by BLE satellite 106 S2, and is thus aware that BLE satellite 106 S3 is located near the trunk based on the vehicle topology described above. Accordingly, the BLE central 104 assigns a CAN address to BLE satellite 106 S3 that identifies or specifies the location of BLE satellite 106 S3 as being the trunk. Similarly, the BLE central 104 determines that BLE satellite 106 S4 is the second-nearest BLE satellite 106 to BLE satellite 106 S2 based on RSSI(s) of its advertising packet(s) received by BLE satellite 106 S2, and is thus aware that BLE satellite 106 S4 is located near the passenger-side back door based on the vehicle topology described above. Accordingly, the BLE central 104 assigns a CAN address to BLE satellite 106 S4 that identifies or specifies the location of BLE satellite 106 S4 as being the passenger-side rear door. The above approach is also applicable to BLE satellite 106 S5.

Accordingly, in the example of FIG. 3, the BLE central 104 is configured to receive an advertising packet from one of the BLE satellites 106 (e.g., S3) having an RSSI value (or average thereof) that is similar to an RSSI value of another of the BLE satellites 106 (e.g., S4). In response, one of the addressed BLE satellites 106 (e.g., S2) is configured to receive advertising packets from the unaddressed BLE satellites 106 (e.g., S3 and S4), and either BLE satellite 106 S2 or the BLE central 104 is configured to determine wireless localization values (RSSIs) of the advertising packets received by BLE satellite 106 S2 from BLE satellites 106 S3 and S4. The BLE central 104 is then configured to determine a location of unaddressed BLE satellites 106 (e.g., S3, S4, S5) responsive to the RSSI value(s) from that particular BLE satellite's 106 advertising packet(s) as received by one of the addressed BLE satellites 106 (e.g., S2). The BLE central 104 can assign a network address (e.g., a CAN address) to those yet-to-be addressed BLE satellites 106 responsive to their determined locations relative to BLE satellite 106 S2.

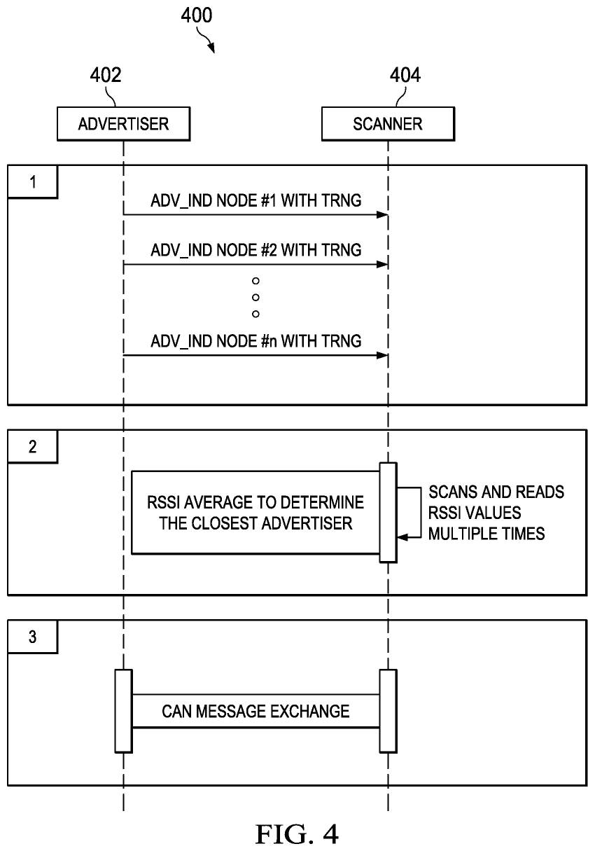

FIG. 4 is a timing diagram 400 of a wireless localization technique in accordance with various examples. The timing diagram 400 shows communications between an advertiser 402 and a scanner 404. In one example, the advertiser 402 corresponds to one of the BLE satellites 106 and the scanner 404 corresponds to the BLE central 104. In another example, the advertiser 402 corresponds to an unaddressed BLE satellite 106 (e.g., S3 in FIG. 3) and the scanner 404 corresponds an addressed BLE satellite 106 (e.g., S2 in FIG. 3).

At time 1, the scanner 404 receives ‘n’ advertising packet(s) that are broadcast over the wireless communication link (e.g., a BT link), such as during an initialization period following the installation of the BLE satellites 106 in the access network 102 (e.g., after the BLE satellites 106 are installed in a vehicle). In the example of FIG. 4, while only a single advertiser 402 is shown, the ‘n’ advertising packet(s) can be broadcast by multiple BLE satellites 106, such as ‘n’ BLE satellites 106. As described, the (or each) advertiser 402 includes a TRNG that is configured to generate an identifier (e.g., a random number) to be included with the advertising packet, because in some cases, the BLE satellites 106 do not yet have an associated, unique identifier (e.g., a CAN address). Accordingly, the BLE satellites 106 are configured to provide a unique identifier (e.g., the TRNG random number) with the advertising packet(s), and before the BLE satellites 106 are addressed, or assigned a CAN address.

At time 2, the scanner 404 (e.g., the BLE central 104 or an addressed BLE satellite 106) determines a wireless localization value (e.g., an RSSI value) of the advertising packets from a particular advertiser 402/BLE satellite 106. In the example of FIG. 4, the scanner 404 scans and receives multiple advertising packets from the particular advertiser 402/BLE satellite 106 and determines an average RSSI responsive to the RSSIs of the advertising packets.

The scanner 404 (e.g., BLE central 104) is thus configured to determine a location of a particular advertiser 402 responsive to the RSSI value(s) from that particular advertiser's 402 advertising packet(s). At time 3, the BLE central 104 assigns a network address (e.g., a CAN address) to the advertiser 402 responsive to its determined location. For example, the BLE central 104 determines the advertiser 402 corresponds to the nearest BLE satellite 106 based on RSSI(s) of its advertising packet(s), and is thus aware that the advertiser 402 corresponds to BLE satellite 106 S1, which is located near the driver-side front door based on the vehicle topology described above.

Accordingly, the BLE central 104 sends a message over the CAN bus 108 that assigns a CAN address to the BLE satellite 106 having the TRNG random number provided by the advertiser 402 (e.g., S1). Subsequently, the assigned CAN address identifies or specifies the location of the BLE satellite 106 having the TRNG random number provided by the advertiser 402 above as being BLE satellite 106 S1, or the driver-side front door. The above approach continues for the remaining advertisers 402, or BLE satellites 106.

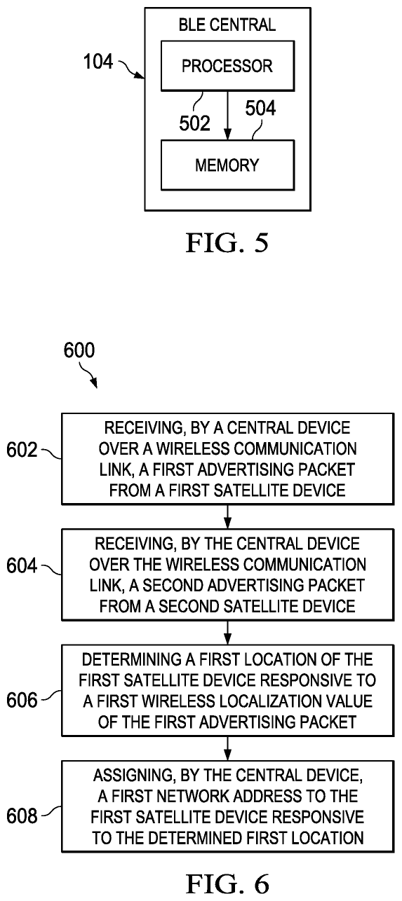

FIG. 5 is a block diagram of a BLE central 104 in the system 100 of FIG. 1 in accordance with various examples. The BLE central 104 includes a processor 502 coupled to a memory 504. The memory 504 is configured to store instructions that are executable by the processor 502. The instructions in the memory 504, when executed by the processor 502, cause the BLE central 104 to be configured to receive a first advertising packet from a first satellite device, such as one of the BLE satellites 106. As described above, the advertising packets are received over a wireless communication link, such as a BLE communication link. The instructions, when executed by the processor 502, also cause the BLE central 104 to be configured to receive a second advertising packet from a second satellite device over the wireless communication link. The instructions, when executed by the processor 502, also cause the BLE central 104 to be configured to determine a first location of the first satellite device responsive to a first wireless localization value of the first advertising packet, and to assign a first wired network address to the first satellite device responsive to the determined first location.

FIG. 6 is a flow chart of a method 600 for addressing using wireless localization in accordance with various examples. The method 600 begins in block 602 with receiving, by a central device over a wireless communication link, a first advertising packet from a first satellite device. For example, the central device is the BLE central 104 and the first satellite device is one of the BLE satellites 106, such as BLE satellite 106 S1. The wireless communication link can be a BLE communication link. The method 600 continues in block 604 with receiving, by the central device over the wireless communication link, a second advertising packet from a second satellite device. The second satellite device is also one of the BLE satellites 106, such as BLE satellite 106 S3.

The method 600 then continues in block 606 with determining a first location of the first satellite device responsive to a first wireless localization value of the first advertising packet. For example, the BLE central 104 is configured to convert the RSSI (or average thereof) into a distance (e.g., one of the distances d1-d6), based on the relation between power density at a distance R from an isotropic antenna transmitting P watts of radio frequency (RF) power. In another example, the BLE central 104 is configured to determine a closest BLE satellite 106. A closest BLE satellite 106 determined responsive to having a greatest RSSI (or average thereof) corresponds to BLE satellite 106 S1, while a farthest BLE satellite 106 determined responsive to having a least RSSI (or average thereof) corresponds to BLE satellite 106 S3. The locations of the remaining BLE satellites 106 can be identified responsive to their relative RSSIs in a similar manner.

The method 600 concludes in block 608 with assigning, by the central device, a first network address to the first satellite device responsive to the determined first location. For example, the BLE central 104 assigns a CAN address to a particular BLE satellite 106 responsive to its determined location. In the above examples, the BLE central 104 determines that BLE satellite 106 S1 is the nearest BLE satellite 106 based on RSSI(s) of its advertising packet(s), and is thus aware that BLE satellite 106 S1 is located near the driver-side front door based on the vehicle topology described above. Accordingly, the BLE central 104 assigns a CAN address to BLE satellite 106 S1 that identifies or specifies the location of BLE satellite 106 S1 as being the driver-side front door. Similarly, the BLE central 104 determines that BLE satellite 106 S6 is the second-nearest BLE satellite 106 based on RSSI(s) of its advertising packet(s), and is thus aware that BLE satellite 106 S6 is located near the hood based on the vehicle topology described above. Accordingly, the BLE central 104 assigns a CAN address to BLE satellite 106 S6 that identifies or specifies the location of BLE satellite 106 S6 as being the vehicle hood. The method 600 can continue using the above approach to determine locations of, and provide network addresses to, the remaining BLE satellites 106 (e.g., S5, S2, S4, and S3).

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means +/−10 percent of the stated value. Modifications are possible in the described examples, and other examples are possible within the scope of the claims.

What is claimed is:

1. A method, comprising:
receiving, by a central device over a wireless communication link, a first advertising packet from a first satellite device;
receiving, by the central device over the wireless communication link, a second advertising packet from a second satellite device;
determining a first location of the first satellite device responsive to a first wireless localization value of the first advertising packet; and
assigning, by the central device, a first network address to the first satellite device responsive to the determined first location.

2. The method of claim 1, wherein determining the first location is responsive to the first wireless localization value relative to a second wireless localization value of the second advertising packet.

3. The method of claim 1, comprising:
receiving, by the central device over the wireless communication link, a third advertising packet from a third satellite device;
responsive to determining a third localization value of the third advertising packet is approximately equal to the second localization value:
receiving, by the first satellite device over the wireless communication link, a fourth advertising packet from the second satellite device; and
receiving, by the first satellite device over the wireless communication link, a fifth advertising packet from the third satellite device;
determining, by the central device, a second location of the second satellite device responsive to a fourth wireless localization value of the fourth advertising packet relative to a fifth wireless localization value of the fifth advertising packet; and
assigning, by the central device, a second network address to the second satellite device responsive to the determined second location.

4. The method of claim 1, wherein the first advertising packet includes a first identifier of the first satellite device, wherein the network address is a controller area network (CAN) address, and wherein assigning the network address comprises sending, by the central device over a CAN bus, a CAN message containing the CAN address and the first identifier.

5. The method of claim 1, wherein the first satellite device is in a predetermined proximal location relative to the central device, wherein the second satellite device is in a predetermined distal location relative to the central device, and wherein the first wireless localization value indicates a distance between the first satellite device and the central device is less than a distance between the second satellite device and the central device.

6. The method of claim 1, wherein the wireless localization value comprises a received signal strength indicator value or an angle of arrival value.

7. The method of claim 1, wherein the wireless communication link is a Bluetooth Low Energy (BLE) communication link, the central device is a BLE central, and the satellite devices are BLE satellites.

8. A system, comprising:
a central device; and
first and second satellite devices coupled to the central device over a wired network bus;
wherein the central device is configured to:
receive, over a wireless communication link, a first advertising packet from the first satellite device;
receive, over the wireless communication link, a second advertising packet from the second satellite device;
determine a first location of the first satellite device responsive to a first wireless localization value of the first advertising packet; and
assign a first network address, over the wired network bus, to the first satellite device responsive to the determined first location.

9. The system of claim 8, wherein the wired network bus is a controller area network (CAN) bus deployed in a vehicle.

10. The system of claim 8, wherein the first location is determined responsive to the first wireless localization value relative to a second wireless localization value of the second advertising packet.

11. The system of claim 8, wherein:
the central device is configured to receive, over the wireless communication link, a third advertising packet from a third satellite device;
responsive to the central device determining a third localization value of the third advertising packet is approximately equal to the second localization value, the first satellite device is configured to:
receive, over the wireless communication link, a fourth advertising packet from the second satellite device; and
receive, over the wireless communication link, a fifth advertising packet from the third satellite device; and
the central device is configured to determine a second location of the second satellite device responsive to a fourth wireless localization value of the fourth advertising packet relative to a fifth wireless localization value of the fifth advertising packet, and assign a second network address to the second satellite device responsive to the determined second location.

12. The system of claim 8, wherein the first advertising packet includes a first identifier of the first satellite device, wherein the network address is a CAN address, and wherein the central device is configured to assign the network address by sending, over a CAN bus, a CAN message containing the CAN address and the first identifier.

13. The system of claim 8, wherein the first satellite device is in a predetermined proximal location relative to the central device, wherein the second satellite device is in a predetermined distal location relative to the central device, and wherein the first wireless localization value indicates a distance between the first satellite device and the central device is less than a distance between the second satellite device and the central device.

14. The system of claim 8, wherein the wireless localization value comprises a received signal strength indicator value or an angle of arrival value.

15. The system of claim 8, wherein the wireless communication link is a Bluetooth Low Energy (BLE) communication link, the central device is a BLE central, and the satellite devices are BLE satellites.

16. A device, comprising:
a processor; and
a memory containing instructions that, when executed by the processor, cause the device to be configured to:
receive, over a wireless communication link, a first advertising packet from a first satellite device;
receive, over the wireless communication link, a second advertising packet from a second satellite device;
determine a first location of the first satellite device responsive to a first wireless localization value of the first advertising packet; and
assign a first wired network address to the first satellite device responsive to the determined first location.

17. The device of claim 16, wherein the instructions, when executed by the processor, cause the device to be configured to:
receive, over the wireless communication link, a third advertising packet from a third satellite device;
responsive to determining a third localization value of the third advertising packet is approximately equal to the second localization value:
cause the first satellite device to receive, over the wireless communication link, a fourth advertising packet from the second satellite device; and
cause the first satellite device to receive, over the wireless communication link, a fifth advertising packet from the third satellite device;
determine a second location of the second satellite device responsive to a fourth wireless localization value of the fourth advertising packet relative to a fifth wireless localization value of the fifth advertising packet; and
assign a second network address to the second satellite device responsive to the determined second location.

18. The device of claim 16, wherein the first advertising packet includes a first identifier of the first satellite device, wherein the network address is a controller area network (CAN) address, and wherein the instructions, when executed by the processor, cause the device to be configured to assign the network address by sending, over a CAN bus, a CAN message containing the CAN address and the first identifier.

19. The device of claim 16, wherein the first satellite device is in a predetermined proximal location relative to the device, wherein the second satellite device is in a predetermined distal location relative to the device, and wherein the first wireless localization value indicates a distance between the first satellite device and the device is less than a distance between the second satellite device and the device.

20. The device of claim 16, wherein the wireless localization value comprises a received signal strength indicator value or an angle of arrival value.
